(19) United States
(12) Patent Application Publication
(10) Pub. No.: US 2024/0210726 A1
(43) Pub. Date: Jun. 27, 2024

(54) CUSTOMIZABLE, BIODEGRADABLE AND/OR COMPOSTABLE EYEGLASSES

(71) Applicant: Four 20/20 Optical Inc., San Francisco, CA (US)

(72) Inventor: Jose Juan Herrera Torres, San Francisco, CA (US)

(73) Assignee: Four 20/20 Optical Inc., San Francisco, CA (US)

(21) Appl. No.: 18/086,170

(22) Filed: Dec. 21, 2022

(51) Int. Cl. G02C 5/00; C08L 97/02

(52) U.S. Cl. CPC G02C 5/008; C08L 97/02; C08L 2201/06; C08L 2205/16

(57) ABSTRACT

Customizable, biodegradable and/or compostable, e.g., hemp-based, eyeglasses and/or frames are provided. Systems, methods, and processes for making such eyeglasses and frames are provided as well.

### BACKGROUND

### Technical Field

The present invention relates to vision care, e.g., via eyeglasses that have an at least partially customizable, biodegradable, compostable, and/or possibly water-soluble component such as those made from hemp fibers and/or derivatives thereof.

### Background Art

Hemp, or industrial hemp, is a botanical class of Cannabis sativa cultivars grown specifically for industrial or medicinal use. It can be used to make a wide range of products. Along with bamboo, hemp is among the fastest growing plants on Earth. It was also one of the first plants to be spun into usable fiber 50,000 years ago. It can be refined into a variety of commercial items, including paper, rope, textiles, clothing, biodegradable plastics, paint, insulation, biofuel, food, and animal feed.

Although chemotype I cannabis and hemp (types II, III, IV, V) are both Cannabis sativa and contain the psychoactive component tetrahydrocannabinol (THC), they represent distinct cultivar groups, typically with unique phytochemical compositions and uses. Hemp typically has lower concentrations of total THC and may have higher concentrations of cannabidiol (CBD), which potentially mitigates the psychoactive effects of THC.

The legality of hemp varies widely among countries. Some governments regulate the concentration of THC and permit only hemp that is bred with an especially low THC content into commercial production.

Hemp in its various forms provide a number of advantages over competitor materials. For example, fiber forms of hemp been used in in a variety of consumer products, e.g., clothing, shoes, accessories, dog collars, and home wares. Hemp is considered a “green” building material due to its positive effects on the environment.

Thus, use of hemp is beginning to gain popularity alongside other natural materials. Like other biomaterials, cannabis processing is done mechanically with minimal harmful effects on the environment. A part of what makes hemp sustainable is its minimal water usage and non-reliance on pesticides for proper growth. It is recyclable, non-toxic, and biodegradable

Accordingly, there exist numerous novel and nonobvious opportunities in the art to exploit hemp fibers and/or derivatives, such as those associated with hemp based-bioplastics, particularly in the field of vision care and consumer goods.

### SUMMARY

In a first embodiment, the invention provides relates to eyeglasses that comprises: a frame that is at least partially compostable and/or biodegradable and at least one lens that may optionally be compostable and/or biodegradable as well. The frame may be made from a plant-based material. The plant-based material is made from or derived from hemp.

Typically, the plant-based material is substantially free from tetrahydrocannabinol (THC). Thus, precursors materials of the eyeglasses may contain no detectable amount of THC. The material may be free of cannabidiol (CBD). The plant-based material may be fibrous.

The eyeglasses of the invention may have no metal part and may be capable of being formed for customizable fit on a human being's face. Thus, the frame may have a riveting portion, a ball hinge portion, a ball lock system. In addition or in the alternative, the frame may have a loose, no snap hinge. In any case, the entire frame may consist essentially of a hemp material.

Luxury version of the invention may be included. For example, the inventive eyeglasses may comprise luxury accessories. However, the glasses themselves may exclude metal. For example, removable accessories may decorate luxury glasses of the invention, the accessories being formed of one or more precious metals such as gold, silver, and platinum, and other high-end materials typically associated with jewelry.

In another embodiment, a frame of a wearable visual improvement device is provided that is at least partially compostable and/or biodegradable and made from a plant-based material.

The visual improvement device may be a frame of eyeglasses installed with at least one lens. In some cases, a removable lens may be used. Typically, the lens is comprised of no plant-based material. The frame may include a temple portion that is comprised of the plant-based material.

In another embodiment, a method of custom fitting glasses on an individual is provided. The method includes the steps of: (a) taking measures of dimensions associated with facial or other body parts of the individual; (b) providing glasses in a frame of a wearable visual improvement device that is at least partially compostable and/or biodegradable and made from a plant-based material; and (c) adjusting the glasses according to the desire(s) of the individual.

### BRIEF DESCRIPTION OF THE FIGURES

FIGS. 1A and 1B, collectively referred to as FIG. 1, illustrate an exemplary eyeglass frame of the invention having some or all of components of traditional eyeglasses frames. FIG. 1A shows the entirety of a frame of the invention. FIG. 1B shows a portion of the frame in front view

FIG. 2 depicts another embodiment of the invention in the form of fully formed eye glasses without any metal components.

FIG. 3 depicts another aspect of the invention in the form of a flow chart

### DETAILED DESCRIPTION

### Definitions and Overview

Before describing the present invention in detail, it is to be understood that the invention is not limited to specific eyeglasses designs, as such may vary. It is also to be understood that the terminology used herein is for the purpose of describing particular embodiments only, and is not intended to be limiting.

In addition, as used in this specification and the appended claims, the singular article forms “a.” “an,” and “the” include both singular and plural referents unless the context clearly dictates otherwise. Thus, for example, reference to “a lens” includes a plurality of lenses, reference to “temple” includes more than one temple, and the like.

In this specification and in the claims that follow, reference may be made to a number of terms that shall be defined to have the following meanings, unless the context in which they are employed clearly indicates otherwise:

In the anatomy of eyeglasses, the term “rim,” as used herein, refers to the part of eyeglasses that hold the lens therein. Rims are generally considered to make glasses more attractive and stylish. Rims can be available in various colors & shapes like circular, rectangular, square, oval, elliptical, etc. Its shape and size create an attractive look for the person. In some cases, rims are full, half, or minimal.

The term “bridge” as used herein refers to a central part of eyeglasses or frame that bears all the weight of the eyeglasses. The bridge connects right and left rims with each other. Depending on the size of the face and nose, the bridge's length can be increased or decreased so as to change the particular design of the eyeglasses.

In the anatomy of eyeglasses, the term “top bar” as used in refers to the upper side of the bridge, which helps to connect two rims of eyeglasses. The top bar also increases the appearance of glasses. In some eyeglasses, there is no top bar. When no top bar is present, the bridge may be broad and has good strength to take all load associated with the eyeglasses.

The term “nose pad” is used to refer to components of eyeglasses that allows the eyeglasses to rest on the nose. It is located on either side of the rims. Often nose pads are in-built for eyeglasses of the invention.

The term “end piece, is the outer end of the rims, which helps to connect hinges to the rims. The term “hinges” refer to pivot point, which is in between the temples and the endpiece.

“Temples” are the arms of typical eyeglasses that allow eyeglasses to sit on ears so as to effect proper grip to the wearer's face.

The terms “luxury.” “luxurious,” and the like refers the state the state of comfort and extravagant living, regardless of whether the state of living is expensive in nature. Often, the term “luxury” is associated with “high end” for the eyeglasses associated with the invention.

The term “substantially identical” as used to describe a plurality of items is used to indicate that the items are identical to a considerable degree, but that absolute identicalness is not required. For example, temple ends of glasses may be substantially identical, but they may exhibit different handedness. The terms “substantial” and “substantially” are used analogously in other contexts involve an analogous definition.

The term “binder” as used herein refers typically to polymeric materials that may serve to bind, adhere, and/or glue particles of material together so as allow portions of the frame to hold its shape. Binders may be applied with or without organic solvents. One or more binders may be mixed with hemp powers to produce the eyeglasses of the invention.

The term “pantoscopic” is a term of art for bifocal corrective lenses. Literally, pantoscopic as an adjective means “seeing everything.” Thus, for example, the term may be applied to eyeglasses or spectacles divided into two segments, the upper being designed for distant vision, the lower for vision of near objects.

The definitions of the terms “consisting of” and “consisting essentially of” can generally be found in MPEP 2111.03. Thus, for example, as used herein, the term “consisting of” is intended to mean including and limited to whatever follows the phrase “consisting of.” Thus, the phrase “consisting of” indicates that the listed elements are required or mandatory and that no other elements may be present. The term “consisting essentially of” has a definition analogous that set forth in MPEP 2111.03, limiting the transitional phrase, when used in a claim to specified materials or steps “and those that do not materially affect the basic and novel characteristic(s)” of the claimed invention.

In general, then, the invention relates to a frame that is at least partially compostable and/or biodegradable and at least one lens that may be compostable and/or biodegradable. Optionally, the lens is effective to serve as a means for vision correction. The frame may be made from hemp or hemp-derived polymers. Advantageously, the invention may be disposed of in yard waste or organic waste containers when they are no longer needed. Thus, the invention is particularly novel and nonobvious when viewed from a green, sustainability, environmental perspective.

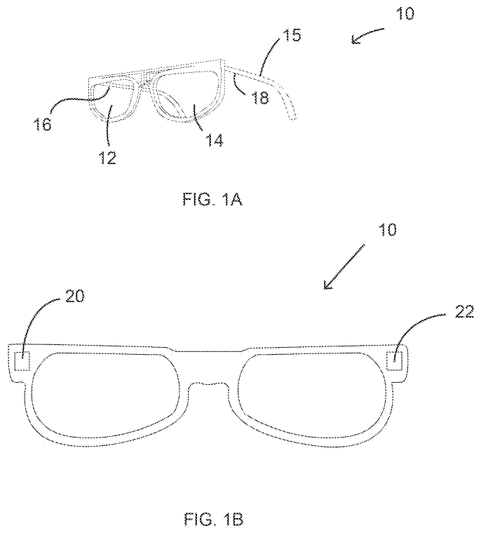

FIG. 1 depicts a frame 10 of the invention having a particularly interesting design and as a composition of matter. Such a frame can be made from a fibrous pulp material that may be made of hemp and typically may not contain any detectable amount of THC. Advantageously, the pulp may be water-based such that waste water disposal in the formation of frames and/or eyeglasses will not have environmental issues, e.g., per state and federal environmental laws.

As shown in FIG. 1A, the frame 10 includes a portion that holds lenses that may be placed in windows 12, 14. Arms 15 extend perpendicularly from the front facing component 16 of the frame. As shown in FIG. 1B, temple portions 16, 18 of arms 15 may extend partially or wholly through holes 20, 22. As discussed below, temple portions 16, 18 may exhibit a luxurious curvature to provide a sense of comfort and/or visual attractiveness.

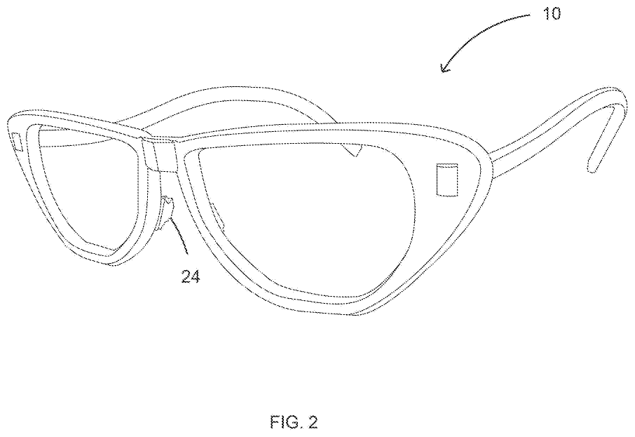

FIG. 2 depicts another frame of the invention that is similar to that shown in FIG. 1, but integrated nose pads 24 are shown. It is important that the eyeglasses of the invention be a density such that no discomfort is caused to the wearer. This is one effectively definition of what is meant when the invention is considered “luxurious.” The frame may be made with color additives that may be naturally derived.

Notably, all luxury versions of the inventive eyeglass frame should include nose pads. However, nose pads are typically, but not necessarily, made from the same material as the rest of the frame. Thus, nose pads of the invention may or may not be made with a metal.

As shown in FIG. 1B, the inventive frame's design may be unique in that the frame has at least one opening 20, 22 through which the temples may be pushed through via assembly. See FIG. 1B Openings in the frame may have at least one angle that will prevent the temple from sliding through the opening. The angle may create a shape of a trapezoid but this shape can change as frame designs are customized.

The invention allows frames to be customized to fit the patients' face shape, aspects of the invention to be customizable including but not limited to the pantoscopic tilt, rear vertex distance, angular wrap, nose shape and size. Also, biometrics (relating to pupillary distance, and ocular/segment heights) may be used in the frame optimization and in possible optometric prescription lens optimization.

### Temples

The temples may be unique to the invention in that at least one temple may be pushed through the frame front upon assembly. The temple may have a least one part that is larger than the smallest opening of the frame so as to not let the temple push completely through the frame opening. The temple may have at least one curve that allows the temple to close as pivoting temple. The temple may be adjustable to fit the dimensions of the frame design and wearers face. The temple may consist of or consist essentially of a hemp material.

Typically, the temples have a curvature associated therewith. Such a curvature may provide a sense of luxury and/or comfort to a person wearing the eyeglasses and/or frames of the invention. In other words, the curvature may allow eyeglasses and/or frames of the invention to hug and/or conform to the shape of a wearer's face and/or head. Alternatively, the curvature may allow the inventive frame to provide for an aesthetically pleasing shape when viewed by the wearer of the frame or when viewed by others looking a person wearing the inventive frame.

In any case, the temples may include a front piece that limits the part from pushing wholly through the frame front. In combination, these factors represent points of novelty and nonobviousness of the invention.

### Lenses

The lenses of the invention may be made from a material that is organic in nature. For example, it is well known that hemp materials are cellulosic in nature. Cellulosic polymers may have ring chemical structures. Thus, for vision purposes, the lenses of the invention may also be comprised of a polymeric material that may be biodegradable and/or compositable, such as a hemp material that has optical properties sufficient for its intended purpose, e.g., human, animal and/or machine vision. Polymeric materials that are optically transparent and dissolvable in water include, for example, methylcellulose, polyacrylic acid, and the like.

For corrective vision purposes, the lenses may be made to fit an individual's prescription issued by an optometrist. The lenses may either be clear or have a tint for fashion and protective reasons. The lenses may be made thin and lightweight. In short, the lenses associated with the invention may be keyed to the shape and design of the frames of the invention as well as made to serve safety purposes. Silicate glass lenses of different thicknesses and indices of reflection/refraction may be used, though such lenses are typically not considered compostable and/or biodegradable.

In some cases, a high-performance polymeric lens may be used. High performance polymeric lenses that have high strength include, for example, those may from polycarbonate. Polycarbonate is both light-weight and sufficiently strong to serve as safety glasses in industrial settings. Although polycarbonate is not considered biodegradable, such lens may be recycled. Similarly, silicate glass may be recycled as well. Thus, the invention may include both biodegradable and recyclable eyeglasses with partially biodegradable and recyclable parts or components.

### Workflow

As discussed above, the invention may involve a method of custom fitting glasses on an individual. The method may involve: (a) taking measurements of dimensions associated with facial or other body parts of the individual; (b) providing glasses in a frame of a wearable visual improvement device that is at least partially compostable and/or biodegradable and made from a plant-based material; and (c) adjusting the glasses according to the desires or needs of the individual.

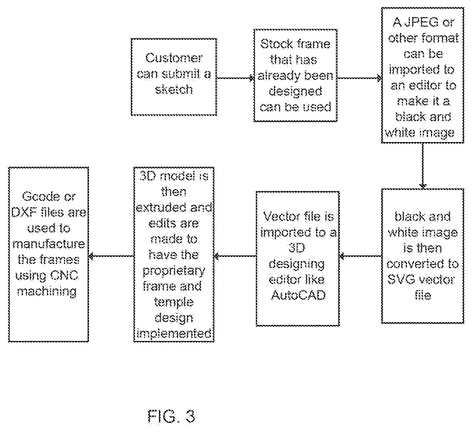

A flow chart that represents a particular embodiment of the invention is depicted in FIG. 3 in the form of a method or a process. The steps of this particular embodiment of the invention include, for example, having a customer submit one or more sketches of the desired frame. One may check for and/or stock frames of the invention that have already been designed and used, e.g., via an electronic computer database. Then, a JPEG or other format file may be used to alter the image of the desired frame. The file may be edited if completely new frames are desired.

Then, vector files are imported to a 3D designing editor like those available from AutoCAD. The 3D model may then be produced, e.g., via extrusion, extruded to form the inventive frame. In any case, Gods or DXF files could be used to produce in the desired frame in bulk.

### Lens Calculator and Optimization Tool

The invention also provides a lens calculator and optimization tool. The lens calculator and optimization too may be used to optimize prescription lenses to account for the physical properties of the lenses to be developed and used. The calculator and optimization tool may be electronic in nature and will typically involve use of appropriate software/hardware/firmware. The tool may be biometric in nature. Thus, the lens calculator may account for at least one biometric measurement obtained from a patient/wearer.

The lens calculator may use at least one lens property like index of refraction but will not be limited to other lens properties like density, thickness, and other relative measurable physical properties. The lens calculator may then optimize a prescription written by a licensed practitioner but to not change the values of the prescription itself but to more so offset induced aberrations that can be calculated and are known to exist among the optical community (induced prism, barrel distortion, pincushion distortion).

The lens calculator may then receive measurements from the frame design to account for how to optimize the frame and lenses.

### Frame Design Process

The frame design process of the invention may allow user of the invention to submit a sketch. The sketch may, for example, start as a hand drawn, computer generated, and/or other digital images. A conversion process may be used to convert the sketch to one or more proper formats, e.g., jpeg, png, pdf, etc. Multiple renderings may be generated to convert said file formats to working classes of files acceptable in other programs, e.g., those supporting 3-D printing technology adapted to produce eyeglasses frames made from, e.g., a hemp-based plastic.

Thus, the invention provides a number of points of novelty and nonobviousness. For example, prescription glasses may be created to suit customer faces as well as to account for environmental and consumer needs and wants. In addition, the invention avoids use of materials such as metal and plastic. For jurisdictions where garbage sorting and disposal and is mandated by law, the invention may allow the inventive eyeglasses to be disposed of in yard/organic waste containers. Thus, the invention nonobviously allows for the conservation of landfill space.

The foregoing description of an embodiment has been provided for the purposes of illustration and description. It is not intended to be exhaustive or to limit an embodiment to the precise forms disclosed. Many modifications and variations will be apparent to the practitioner skilled in the art. Particularly, while the embodiments of invention as described above are described in the context of eyeglasses, it will be evident that the invention is applicable to other types of devices that enhance individuals' ability to see. Similarly, while the embodiments described above are described in the context of eyeglasses, the invention may involve other types of visual improvement devices.

The embodiments were chosen and described in order to best explain the principles of an embodiment and its practical application, thereby enabling others skilled in the art to understand an embodiment for various embodiments and with various modifications that are suited to the particular use contemplated. Variations of the invention are possible. For example, when the invention is provided as a “compostable” item, the item may be whole, partially, or somewhat compostable. Thus, it is intended that the scope of an inventive embodiment be defined by the following claims and their equivalence, in view of the claim interpretation guide as set forth in the present specification.

In short, the claims set forth below should be interpreted in its broadest reasonable sense, in view of the disclosure provided above, but not so broad as to allow for invalidation thereof.

What is claimed is:

1. Eyeglasses, comprising: a frame that is at least partially compostable and/or biodegradable, and at least one lens that may be dissolvable, compostable and/or biodegradable in water.

2. The eyeglasses of claim 1, wherein the frame is made from a plant-based material.

3. The eyeglasses of claim 2, wherein the plant-based material is made from or derived from hemp.

4. The eyeglasses of claim 3, wherein the plant-based material is substantially free from tetrahydrocannabinol (THC).

5. The eyeglasses of claim 4, containing no detectable amount of THC.

6. The eyeglasses of claim 3, wherein the plant-based material is fibrous.

7. The eyeglasses of claim 1, having no metal part.

8. The eyeglasses of claim 1, capable of being formed for customizable fit on a human being's face.

9. The eyeglasses of claim 1, having a riveting portion, a ball hinge portion, a ball lock system, or a loose, no snap hinge.

10. The eyeglasses of claim 2, wherein the entire frame consists essentially of a hemp material.

11. The eyeglasses of claim 1, further comprising a luxury accessory.

12. The eyeglasses of claim 1, wherein the luxury accessory is comprised of a precious metal.

13. A frame of a wearable visual improvement device that is at least partially compostable and/or biodegradable and made from a plant-based material selected from hemp and derivatives thereof.

14. The frame of claim 13, wherein the visual improvement device is a frame of eyeglasses.

15. The frame of claim 13, installed with at least one lens.

16. The frame of claim 13, installed with a removable lens.

17. The frame of claim 13, wherein the lens is comprised of no plant-based material.

18. The frame of claim 14, wherein a temple portion of the frame is comprised of the plant-based material.

19. A method of custom fitting glasses on an individual, comprising:
(a) taking measures of dimensions associated with facial or other body parts of the individual;
(b) providing glasses in a frame of a wearable visual improvement device that is at least partially compostable and/or biodegradable and made from a plant-based material; and
(c) adjusting the glasses according to desires of the individual.

20. The method of claim 19, wherein the plant-based material is a hemp material.
